(19) United States
(12) Patent Application Publication
(10) Pub. No.: US 2010/0258058 A1
(43) Pub. Date: Oct. 14, 2010

(54) Grouper Module

(76) Inventor: Keith M. Neel, Port St Joe, FL (US)

Correspondence Address: Keith M. Neel, 901 16th Street, Port Saint Joe, FL, 32456, US

(21) Appl. No.: 12/683,165

(22) Filed: Jan. 6, 2010

Related U.S. Application Data
(60) Provisional application No. 61/212,144, filed on Apr. 9, 2009.

(51) Int. Cl. A01K 61/00

(52) U.S. Cl. 119/221

(57) ABSTRACT

The present invention relates generally to artificial ocean reefs, and more specifically to a versatile artificial reef module which will effectively provide protection and shelter for marine life, especially for bottom dwelling fish species and lobster. Other designs are costly and difficult to manufacture, prone to becoming less useful because of tipping over during deployment or storm events, and not adequately imitating natural and preferred habitat.

### CROSS-REFERENCE TO RELATED APPLICATIONS

Provisional Application U.S. 61/212,144 filed on Apr. 9, 2009 granted

### STATEMENT REGARDING FEDERALLY SPONSORED RESEARCH OR DEVELOPMENT

Not Applicable.

### REFERENCE TO SEQUENCE LISTING, A TABLE, OR A COMPUTER COMPACT DISC APPENDIX

Not Applicable

### BACKGROUND OF THE INVENTION

The present invention relates generally to artificial ocean reefs, and more specifically to a versatile artificial reef module which will effectively provide protection and shelter for marine life, especially for bottom dwelling fish species and lobster. Other designs are costly and difficult to manufacture, prone to becoming less useful because of tipping over during deployment or storm events, and not adequately imitating natural and preferred habitat.

### BRIEF SUMMARY OF THE INVENTION

This patent describes a unique artificial reef design constructed of steel-reinforced concrete that provides habitat for bottom dwelling fish species and crustaceans, such as grouper, snapper, and lobster. The artificial reef simulates “cave” and “ledge” natural hard bottom habitat by forming a large internal volume and floor area, restricted internal access, and solid overhead structure. These features provide security from predation sought by bottom dwelling fish species. The design also incorporates features to reduce module subsidence, and has a low vertical profile useful to limit detection by sonar equipment. Furthermore, the manufacturing complexity is low; the mold equipment used to manufacturing the module is simple and easily derived from existing commercial molds, and provides for low production costs relative to more complex designs. The construction is durable and long lasting. The design is stable, will not tip over, and is simple to deploy in an upright orientation.

### BRIEF DESCRIPTION OF THE SEVERAL VIEWS OF THE DRAWINGS

FIG. 1 is a perspective view of the preferred embodiment of the invention.

FIG. 2 is a detailed plan view of an embodiment of the invention.

### DETAILED DESCRIPTION OF THE INVENTION

The world's oceans cover approximately 70 percent of the Earth's surface and support a vast community of sea life. Over the centuries, man has harvested this sea life for food and harvested various sea bottom aggregates for raw materials. This utilization of the ocean's resources has led to varying degrees of natural reef degradation. In recent years, this destruction has been recognized and methods for preservation, restoration, and enhancement have been developed. One such development is the artificial reef.

A number of inventions to this end have been developed and patented. One is that of Van Doren, U.S. Pat. No. 4,997,311, issued on Mar. 5, 1991. Van Doren teaches an artificial reef module including a thin-walled, plastic hemispherical dome, perforated by several access ports. The circular edge of the dome is turned diametrically outward and back to form a circumferential trough. This trough is filled with concrete once the module is transported to the deployment site. Once the concrete cures, the module is released and parachutes to the bottom, using the drag induced by the water moving upward through the dome and out the access ports. The concrete serves as ballast, providing stability for the lightweight plastic dome as it rests on the sea floor. A problem with Van Doren is that the plastic structure degrades and is not durable in the ocean environment. Plastic also produces gasses and chemical byproducts as it ages which are environmentally toxic. Plastic and other composite materials are often excluded as approved artificial reef materials in many jurisdictions.

Lowe, U.S. Pat. No. 5,173,006, issued on Dec. 22, 1992, reveals a fiberglass pyramid artificial reef module. A disadvantage of this design is the fiberglass construction, which is not an accepted artificial reef material in some jurisdictions due to out-gassing and production of toxic chemical byproducts as the module ages. Fiberglass modules also tend to be less stable due to light weight and are prone to movement and loss during storm events.

Hudson, U.S. Pat. No. 5,215,406, issued on Jun. 1, 1993, reveals a dome structure constructed of concrete having a hollow interior region, an apex with a ventilation port used to create a venturi effect, and an access port at the base. Stones are embedded into the dome inner surface and the base bottom surface. This design presents several disadvantages with respect to the current invention. The Hudson design has a lower floor space capacity for a fixed area module base as compared to the invention described by this patent. The lower floor space capacity of the module reduces the area available to bottom dwelling fish and lobster, which normally rest on the bottom of the module rather than floating suspended in the internal volume. Also, the Hudson design has higher manufacturing costs due to construction complexity driven by the module's dome shape and incorporation of rocks in the inner surfaces. The mold used to construct the module is more difficult to construct and is more costly than that of the current invention.

Barber et al, U.S. Pat. No. 5,564,369, issued on Oct. 15, 1996, reveals a hollow concrete ball with a plurality of orifices positioned randomly around the outside of the ball, with the largest access located on the ball's top. This design does not provide any cave habitat in that its top is open. The other access holes are too small to accommodate mature individuals of most bottom dwelling fish. As most bottom dwelling fish species seek enclosed hiding places, especially overhead, this design is not sufficient for this purpose.

Walter, U.S. Pat. No. 6,042,300, issued on Mar. 28, 2000, reveals a concrete pyramid artificial reef module comprised of concrete beams inserted through a number of automotive tires. This interior volume of this design is open to the exterior, allowing predators free access. It does not provide significant hiding places or sanctuary for mature bottom dwelling fish species. It also has high vertical relief, making it easy to detect with recreational sonar equipment. The load carrying surface area is small compared to the current invention, which potentially could lead to greater subsidence. Tires are not approved artificial reef materials in some jurisdictions. The device is prone to tipping during deployment.

Bartkowski, U.S. Pat. No. 6,186,702, issued on Feb. 13, 2001, reveals a concrete pyramid structure with multiple access holes on each side and an open bottom. This design seeks to enhance stability by utilizing holes in the top and sides to allow water to flow through instead of applying a tipping force. It also seeks to allow light inside the module to promote certain types of marine life. This design does not simulate natural reef cave habitat in that the design is relatively open with many large access ports that permit unrestricted access by predators. This configuration limits the ability of fish to hide as they are visible from most directions. It also has high vertical relief, making it easy to detect with recreational sonar equipment. The load carrying surface area is small compared to the current invention, which potentially could lead to greater subsidence. The device is prone to tip over on its side during deployment.

Walter, U.S. Pat. No. 7,513,711 B1, issued on Apr. 7, 2009, reveals concrete pyramid, cylinder, and box structures utilizing concrete frames with attached concrete panels with embedded limestone. The primary feature of this design is the use of embedded soft limestone and other indigenous rocks to promote encrustation and borrowing of marine animals on the artificial reef module panels. The described designs do not adequately provide “cave” habitat due to the large access holes and open module top surfaces. They also are more complex to construct as separate steps are required to fabricate and assemble the frames and the concrete panels with embedded indigenous rock. These modules also are more easily detected by sonar due to the high vertical dimensions. The load carrying surface area is small compared to the current invention, which potentially could lead to greater subsidence. The device is prone to tipping during deployment.

### DRAWINGS

The foregoing and other objects and advantages will appear from the description to follow. In the description, reference is made to the accompanying drawing, which forms a part hereof, and in which is shown by way of illustration specific embodiments in which the invention may be practiced. These embodiments will be described in sufficient detail to enable those skilled in the art to practice the invention, and it is understood that other embodiments may be utilized and that structural changes may be made without departing from the scope of the invention.

The following detailed description is, therefore, not to be taken in a limiting sense, and the scope of the present invention is best defined by the appended claims.

### DETAILED DESCRIPTION OF THE PREFERRED EMBODIMENT

The following discussion describes in detail one embodiment of the invention and several variations of that embodiment. This discussion should not be construed, however, as limiting the invention to those particular embodiments. Practitioners skilled in the art will recognize numerous other embodiments as well. For definition of the complete scope of the invention, the reader is directed to the appended claims.

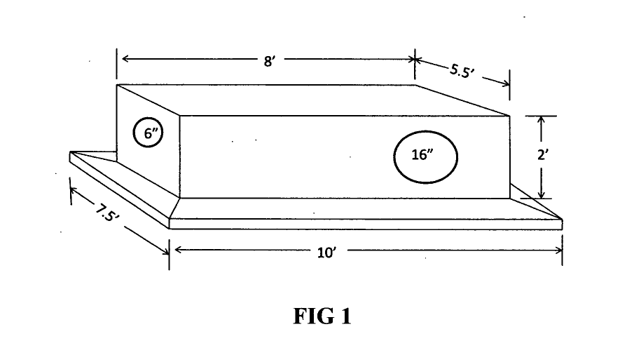

FIG. 1 is an illustrative view of the present invention. The present invention is an artificial reef that simulates “cave” and “ledge” natural hard bottom habitat, which is preferred by most species of bottom-dwelling fish. Specific grouper species that are known to utilize this type of habitat include gag grouper, red grouper, black grouper, and warsaw grouper. Other species, such as mangrove snapper, spiny lobster, and shovelnose lobster, also use this type of habitat. The use of this invention can augment the amount of this type of habitat over that available naturally in the local marine environment. This is especially true in areas such as the northern Gulf of Mexico, which consists primarily of huge expanses of sand bottom.

The primary function of the present invention is to provide shelter for bottom-dwelling fish species and lobster from marine predators, such as sharks and jewfish. The structure itself also acts as a substrate that barnacles, algae, and hard and soft coral can attach and grow. This forms a basis for the marine food chain that would not otherwise exist in areas with flat, featureless, sand bottom.

The present invention provides a relatively large enclosed rectangular volume that has a solid roof overhead, a large floor area, a minimized vertical profile, restricted internal access, and large load bearing bottom panels. The device is of robust steel-reinforced concrete construction, and is long lasting in the marine environment. The estimated useful life of this design is several decades. The device is stable, easy to deploy with straps through the access holes or suitably positioned and reinforced deployment rings, and is unlikely to deploy upside-down due to its unique shape. The preferred embodiment weighs approximately 4000 lbs and will not move after deployment due to wave action or storm events.

The large enclosed volume and maximized floor area accommodate a larger number of bottom-dwelling fish and lobster, as these species generally rest on the bottom rather than floating in the water-column. This is especially true when these species seek sanctuary from predators.

The relatively small vertical profile has the advantage of being difficult to detect by sonar, especially those used for recreational fishing. This is useful if the module is used as a “Refugia” reef, where the primary objective is the reef to remain undetected and unharvested. Likewise, this characteristic is useful if the module is used as a “secret” reef for private individuals, as the desired goal in that case is to prevent detection and harvesting by other competing fishermen.

The access holes are sized to allow ingress/egress of all but the largest targeted bottom-dwelling fish and to prevent entry of large predators. The large load bearing bottom panels support the weight of the module with a relatively large surface area, minimizing settling and sand burial.

The rectangular shape lends itself to lower production costs, as the mold is simple and straight-forward to produce. The mold can be constructed from existing concrete septic tanks molds that are available commercially. The module itself is cast as a single unit, which makes it relatively cheap and easy to produce when compared to other more complicated artificial reef designs that require more complicated molds, utilize frames or other stabilizing structures, and/or require assembly of multiple parts.

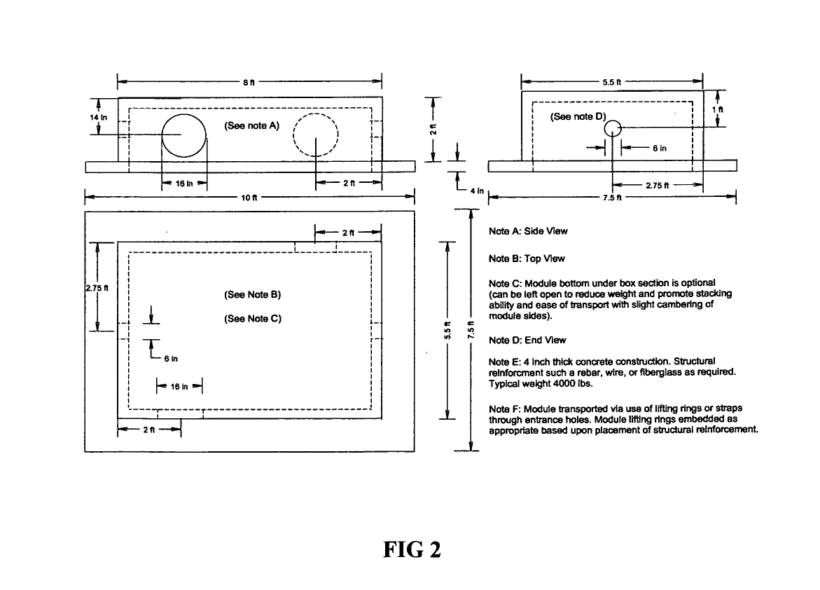

In its best embodiment, the exact dimensions of the present invention are optimized to match the height of the natural ledges and caves in the local marine environment. The embodiment in FIG. 2 is optimized for the northwestern Gulf of Mexico. The module bottom under the box section can be left out to reduce weight and, along with suitable cambering and/or sloping of the module sides, allow stacking of the modules to minimize storage and vessel deck area requirements during transport and module deployment.

Other embodiments that do not change the essence of the present invention include:
1) Stacking multiple instances of the best embodiment on each other, creating multiple “decks” in a single module.
2) Changing any dimension of the module.
3) Changing the number, size, and position of the access holes.
4) Changing the thickness of the concrete.
5) Changing the exact composition of the concrete panels.
6) Adding or deleting the module bottom under the box section.
7) Sloping of the module sides to promote stacking of modules.
8) Type or placement of structural reinforcement.
9) Type or placement of deployment hooks or rings.
10) Modifying the rectangular shape to include spherical shapes or rounded corners.

1-7. (canceled)

8. An object of the present invention is to provide simulated “cave” and “ledge” habitat for bottom-dwelling fish and crustaceans, such as grouper and lobster, while providing hiding places and sanctuary for these and other marine species, and limiting access to predators, such as sharks and other groupers.
